(19) United States
(12) Patent Application Publication
(10) Pub. No.: US 2018/0281061 A1
(43) Pub. Date: Oct. 4, 2018

(54) PRESSED POWDER MAGNETIC CORE MATERIAL, PRESSED POWDER MAGNETIC CORE, AND PRODUCTION METHOD THEREOF

(71) Applicant: NTN CORPORATION, Osaka (JP)

(72) Inventors: Noritaka KAKO, Mie (JP); Kouya OOHIRA, Mie (JP)

(21) Appl. No.: 15/766,788

(22) PCT Filed: Oct. 5, 2016
(86) PCT No.: PCT/JP2016/079571

§ 371 Date: Apr. 6, 2018

(30) Foreign Application Priority Data
Oct. 6, 2015 (JP) 2015-198691

(51) Int. Cl. B22F 1/02; B22F 3/00; H01F 1/153; H01F 27/255; H01F 1/24; H01F 41/02; C22C 45/00

(52) U.S. Cl. CPC B22F 1/02; B22F 3/006; H01F 1/153; C22C 2202/02; H01F 1/24; H01F 41/02; C22C 45/008; H01F 27/255

(57) ABSTRACT

To provide a pressed powder magnetic material having excellent work safety during production of a pressed powder magnetic core and imposing less environmental burden; a pressed powder magnetic core having a high magnetic flux density, a high magnetic permeability, a low iron loss, and excellent mechanical strength; and a production method thereof. The pressed powder magnetic core material contains a granulation binder, a soft magnetic powder in which an insulating coating film is formed on the particle surface, and a glass frit whose softening point is a temperature being at least 100° C. lower than a magnetic annealing temperature; the soft magnetic powder being an iron-based amorphous alloy powder, the glass frit being contained in an amount of 0.3 to 1.0% by mass, the granulation binder being a polyvinyl alcohol having a degree of polymerization of 1000 or less and a degree of saponification of 50 to 100% by mole.

### TECHNICAL FIELD

The present invention relates to a pressed powder magnetic core material, a pressed powder magnetic core using the material, and a production method thereof.

### BACKGROUND ART

A pressed powder magnetic core is an electromagnetic part obtained by subjecting soft magnetic powder, whose surface is subjected to an insulation process, to a compression molding. It is required for the electromagnetic part to have a smaller and more efficient magnetic core, in terms of resource saving and energy saving. In order to satisfy these requirements, it is necessary to improve properties of the pressed powder magnetic core so that a magnetic flux density is increased, a magnetic permeability is increased and an iron loss is decreased.

Conventionally-known magnetic materials are a magnetic material wherein a surface of a powder containing iron as a main component is coated with a coating film containing a silicone resin and a pigment (Patent Document 1); and a composite soft magnetic material having a high strength, a high specific resistance and a low loss, which mainly contains a composite oxide in which a grain boundary layer of an Fe-based soft magnetic metal particles has Fe, a bivalent metal and Mg (Patent Document 2). In addition, known as the pressed powder magnetic core are a pressed powder magnetic core obtained by mixing an amorphous soft magnetic alloy powder, a glass powder whose softening point is lower than a crystallization temperature of the amorphous soft magnetic alloy powder, and a binder resin containing an aqueous polyvinyl solution or a polyvinyl butyral solution, press-molding the mixture to form a molded product, and anneal-treating the resulting molded product at a temperature lower than the crystallization temperature of the amorphous soft magnetic alloy powder (Patent Document 3); a pressed powder magnetic core having low-melting-point glass layers on surfaces of insulating films surrounding metal magnetic particles, in which at least a part of the insulating films are annealed to form a liquid phase and then are solidified (Patent Document 4); a pressed powder magnetic core in which a low temperature softening material containing a first inorganic oxide whose grain boundary phase formed between soft magnetic particles has a softening point lower than an annealing temperature of the soft magnetic particle is combined with a high temperature softening material containing a second inorganic oxide having a softening point higher than the annealing temperature (Patent Document 5); a pressed powder magnetic core in which a magnetic powder is mixed with a glass powder whose transition point is lower than a crystallization temperature of the magnetic powder, a difference between the transition point of the glass powder and the crystallization temperature of the magnetic powder is 50° C. or higher, and a difference between the crystallization temperature of the glass powder and the crystallization temperature of the magnetic powder is 50° C. or lower (Patent Document 6), and the like.

As described in Patent Document 1, however, when a silicone resin is used as a coating material of the magnetic material, there is a problem that safety and environmental measures must be taken into account because a solvent therefor often contains an organic solvent or harmful substances. The invention described in Patent Document 2 relates to a magnetic material obtained by adding an Mg powder to a soft magnetic powder, which has been subjected to an oxidation treatment, and subjecting a mixed powder, obtained by mixing the resulting mixture in a rolling stirring mixing granulator, to an oxidation treatment in which the mixed powder is heated in an inert gas atmosphere or vacuum atmosphere, followed by, if necessary, heating in an acidic atmosphere. In this case, there is a problem that safety should be taken into account because the Mg powder is used. As to the pressed powder magnetic core described in Patent Document 3, there is a problem that safety should be taken into account, because the surface of the amorphous soft magnetic alloy powder is coated with the heat-resistant protecting coating film, which is a silane coupling agent, and a polyvinyl butyral solution may sometimes be used. The pressed powder magnetic cores described in Patent Documents 4 to 6 use the low-melting-point glass layer or glass powder, but previously binding the soft magnetic powders to each other is not taken into consideration with respect to the glass layer and the glass powder.

An Fe—Si, Sendust, or iron-based amorphous alloy powder is used for the soft magnetic material in the pressed powder magnetic core used in a frequency range of several tens to several hundreds of kHz in a reactor or choke coil. This is because the material has a high electric resistivity and thus can suppress eddy current loss caused in a high frequency range. It has also an advantage in which a strain amount is small during molding because of small magnetic strain.

The alloy powder, however, easily causes damages such as chips and cracks in a step for obtaining a molded product therefrom, which is a previous step of a production step of the pressed powder magnetic core, and there is a problem that collapse occurs by a slight load during the compression molding.

### PRIOR ART DOCUMENTS

### Patent Documents

Patent Document 1: JP 2003-303711 A
Patent Document 2: JP 2009-141346 A
Patent Document 3: JP 2010-027854 A
Patent Document 4: JP 2010-206087 A
Patent Document 5: JP 2012-230948 A
Patent Document 6: JP 2014-229839 A

### SUMMARY OF THE INVENTION

### Problems to be Solved by the Invention

In order to solve the problems described above, the present invention has been made, and the present invention aims at providing: a pressed powder magnetic material having an excellent work safety during production of pressed powder magnetic core and imposing less environmental burden; a pressed powder magnetic core obtained by compression-molding the magnetic material, which has a high magnetic flux density, a high magnetic permeability, a low iron loss, and excellent mechanical strength; and a method for producing the same.

### Means for Solving the Problem

The pressed powder magnetic core material of the present invention contains a granulation binder; a soft magnetic powder in which an insulating coating film is formed on a particle surface; and a glass frit whose softening point is a temperature being at least 100° C. lower than a magnetic annealing temperature.

In particular, the soft magnetic powder described above is an iron-based amorphous alloy powder. The glass frit described above is contained in an amount of 0.3 to 1.0% by mass based on the whole amount of the soft magnetic powder. The granulation binder described above is a polyvinyl alcohol (hereinafter referred to as “PVA”) having a degree of polymerization of 1000 or less and a degree of saponification of 50 to 100% by mole.

The pressed powder magnetic core of the present invention contains the pressed powder magnetic core material described above, and has a radial crushing strength of 10 MPa or more.

In a method for producing the pressed powder magnetic core of the present invention, the pressed powder magnetic core is produced using the pressed powder magnetic core material, the method including: a step in which the pressed powder magnetic core material described above is subjected to a compression molding at a temperature approximately equal to or lower than a melting point of the granulation binder; and a step in which a compression-molded product obtained by the compression molding is subjected to a magnetic annealing.

### Effect of the Invention

The pressed powder magnetic core material of the present invention contains the granulation binder, the soft magnetic powder in which the insulating coating film is formed on the particle surface, and the glass frit having a softening point of a temperature being at least 100° C. lower than the magnetic annealing temperature, and thus the glass frit is uniformly dispersed to the soft magnetic powder. In addition, it contains the glass frit whose softening point is a temperature being at least 100° C. lower than the magnetic annealing temperature, and thus a pressed powder magnetic core having a radial crushing strength of more than 10 MPa can be obtained. Furthermore, the glass frit is contained in an amount of 0.3 to 1.0% by mass, and thus a pressed powder magnetic core, which is well-balanced between the binding of the soft magnetic powder to each other and the magnetic permeability, can be obtained.

The method for producing the pressed powder magnetic core of the present invention includes the step of compression molding at a temperature of around the melting point of the granulation binder or lower, and the step of magnetic annealing, and thus the fluidity of the granulation binder is increased to increase the number of points of contact between the soft magnetic powder such as iron-based amorphous alloy and the binder, thus resulting in dramatic improvement of the shape-keeping property of the molded product. In addition, the glass frit, which is melted and solidified in the magnetic annealing step, enhances the strength of the pressed powder magnetic core after the magnetic annealing. As a result, a pressed powder magnetic core of an iron-based amorphous alloy can be obtained.

### BRIEF DESCRIPTION OF THE DRAWINGS

FIGS. 1(a) and 1(b) illustrate states during compression molding.

FIGS. 2(a) and 2(b) illustrate states during magnetic annealing.

### MODE FOR CARRYING OUT THE INVENTION

A phenomenon in which damages such as chips and cracks are easily caused and collapse easily occurs by slight load during compression molding when the soft magnetic powder is formed into a molded product obtained in a previous step of the production of the pressed powder magnetic core has been studied.

The soft magnetic alloy powder such as an iron-based amorphous powder has a high hardness, and thus it has a poor plastic deformation during the compression molding. Rearrangement of particles is, accordingly, dominant for the mechanism of the densification of the alloy powder. This is a process in which each particle is close-packed while searching for a space during the compression molding. Here, given that the soft magnetic alloy powder is formed of spherical particles having a uniform size, spaces are formed between the particles even if the particles are close-packed. This shows that the density is decreased, and both the magnetic flux density and the magnetic permeability are also decreased. In usual, the soft magnetic alloy powder has a particle size distribution with a width of 1 to 100 μm or 30 to 300 μm. It is possible, therefore, to do the densification in a manner in which spaces between large particles are filled with small particles.

Addition of fine particles having a size of 20 μm or less are performed in the pressed powder magnetic core used in a frequency range of several tens to several hundreds of kHz in a reactor or choke coil, in order to reduce the eddy current loss caused in the high frequency range. The fine particles having a size of 20 μm or less are remarkably poor in the fluidity, and thus it is difficult to automatically insert the powder to a mold, and there are issues of segregation (separation of rough powder from fine powder) upon conveyance and invasion of the powder into clearances of a mold for molding. The entanglement of the particles to each other upon the molding is dominant, for the shape-keeping property of the pressed powder after the compression molding. At that time, the particles are more likely to get mechanically entangled as the shape of the particles is more warped or the specific surface area is larger. It has been found that the Fe—Si, Sendust, or iron-based amorphous alloy powder has a high hardness, and thus it is difficult to cause mechanical entanglement, and it is difficult to have the shape-keeping property upon the compression molding. In particular, when the alloy powder is molded alone, the resulting molded product has a low shape-keeping property so that the product is collapsed when the compression-molded product is discharged.

The present inventors have found that when a granulation binder is blended with a soft magnetic alloy powder containing a fine powder, in terms of the productivity and the shape-keeping property, the soft magnetic powder particles adhere to each other, the shape-keeping property after molding becomes higher, and the damages such as chips and cracks are prevented upon conveyance. The present inventors have also found that the soft magnetic powder, obtained by blending with the binder and granulating the mixture, has excellent fluidity and thus the productivity of the pressed powder magnetic core is improved. It has been further found that when a low softening point glass frit is blended in a given amount, and warm molding is performed at a temperature around a melting point of the granulation binder, the strength of the pressed powder magnetic core is, in particular, effectively made higher. The present invention has been made based on the findings described above.

Examples of the soft magnetic powder used in the pressed powder magnetic core material of the present invention include Fe, Fe—Si, Fe—Si—Al, Fe—Si—Cr, Fe—Ni, Fe—Ni—Mo, Fe—Co, Fe—Co—V, Fe—Cr, Fe-based amorphous alloy, Co-based amorphous alloy, Fe-based nanocrystal alloy, and metal glass. The powder may be used as a mixture of multiple kinds described above.

Of the soft magnetic powder, a powder whose particle size is spherical is preferable. The iron-based amorphous alloy powder is particularly preferable, because a magnetic core having a high magnetic flux density, a high magnetic permeability, and a low iron loss can be obtained.

A high heat-resistant, insulating coating film is formed on the particle surface of the soft magnetic powder. The insulating coating film can be used without particular limitation so long as it is used for a pressed powder magnetic core. Specifically, it can be selected from oxides of B, Ca, Mg, Al, Si, Ti, V, Cr, Mn, Fe, Co, Ni, Zn, Y, Zr, Mo, and Bi, and composite oxides thereof; carbonates of Li, K, Ca, Na, Mg, Fe, Al, Zn, and Mn, and composite carbonates thereof; silicates of Ca, Al, Zr, Li, Na, and Mg, and composite silicates thereof; alkoxide of Si, Ti, and Zr, and composite alkoxide thereof; phosphates of Zn, Fe, Mn, and Ca, and composite phosphates thereof; heat-resistant resins such as a silicone resin, epoxy resin, polyimide resin, polyphenylene-sulfide resin, and polytetrafluoroethylene resin, and the like. The insulating coating films maybe used alone or as a mixture of multiple kinds. A method for coating the insulating coating film is not particularly limited, and it is possible to employ, for example, a tumbling fluidized bed-type coating method, various chemical conversion coating methods, and the like.

The granulation binder, which can be used in the pressed powder magnetic core material of the present invention, has a function as a “glue” or “adhesive” which binds the soft magnetic powder particles to each other. When the binder is blended, the soft magnetic powder particles adhere to each other, and the shape-keeping property after the molding is increased, and the damages such as chips and cracks are prevented upon conveyance.

As the granulation binder, it is possible to use PVA, polyvinyl pyrrolidone, hydroxypropyl cellulose, hydroxpropyl methylcellulose, hydroxypropyl methylcellulose phthalate, hypromellose acetate succinate, and the like. As a granulation method, it is possible to employ a tumbling fluidized bed method, fluidized-bed method, spray drying method, stirring method, extrusion method, and the like. Of these, a tumbling fluidized bed method is preferable in which a binder solution is sprayed to the powder floated using air and a rotor.

Among the granulation binders described above, water-soluble PVA is preferable. Of PVAs, a PVA having a degree of polymerization of 1000 or less, preferably a degree of polymerization of 100 to 1000, and a degree of saponification of 50 to 100% by mole is preferable. From the PVA described above, an aqueous solution having a lower viscosity can be obtained compared with, for example, PVA having a degree of polymerization of 1000 or more and a degree of saponification of 70 to 100% by mole, when the aqueous solutions have the same concentration therefrom. When the aqueous PVA solution having a low viscosity is used as the binder liquid, the uniformly granulated soft magnetic powder can be obtained, and the excellent compressibility is obtained. When the aqueous PVA solution having a low viscosity is used, large powder particles having a size of about 50 μm or more are not easily granulated (do not adhere) to each other, and a granulated powder in which a large powder particle is wrapped with small powder particles is obtained. In addition, a part of the aqueous PVA solution adheres to the powder, which does not contribute to granulation but coats the surface of the powder. The uniform coating layer on the powder surface contributes greatly to the shape-keeping property of compression-molded product, and improves the handling property.

On the other hand, for example, an aqueous PVA solution having a degree of polymerization of 1000 or more and a degree of saponification of 70 to 100% by mole is used as the binder liquid, rough granulated powder is likely to be formed because of the high viscosity. The rough granulated powder having a size of several hundreds of μm or more has a good fluidity, but its bulk density is low, and thus it is difficult to obtain the magnetic core having a high density, even if molding is performed at a high pressure. In the granulated powder having a low apparent density, molding pressure loss is caused by friction caused among the particles even if the molding is performed at a high pressure, and thus it is difficult to obtain the magnetic core having a high density. As a result, not only various magnetic properties, represented by the magnetic permeability and the iron loss, are not improved but also the strength is remarkably decreased.

It is preferable that the granulation binder is blended in a content of 0.3 to 1.0% by mass to the whole amount of the soft magnetic powder.

As the glass frit, which can be used in the pressed powder magnetic core material of the present invention, a glass frit whose softening point is a temperature being at least 100° C. lower than the magnetic annealing temperature can be used. Here, the magnetic annealing temperature refers to a temperature of a treatment for removing crystal strain, caused during the production of a soft magnetic metal powder and each treating step such as compression molding. The atmosphere of the magnetic annealing, which can be used, is an inert atmosphere such as nitrogen or argon, an acidic atmosphere such as room air, air, oxygen or steam, a reducing atmosphere such as hydrogen. The temperature of the magnetic annealing is from about 600 to 700° C. for Fe (pure iron), from about 700 to 850° C. for Fe—Si, Fe—Si—Al, Fe—Si—Cr, Fe—Ni, Fe—Ni—Mo, Fe—Co, Fe—Co—V, or Fe—Cr, and from about 450 to 550° C. for a Fe-based amorphous alloy or Co-based amorphous alloy. The retention time of the magnetic annealing is from about 5 to 60 minutes though it depends on the size of a part. The time is set so that the inside of the part can be sufficiently heated.

As described above, although the iron-based amorphous alloy powder is subjected to the magnetic annealing at 450 to 550° C., the glass frit is selected from glass frit whose softening point is at least 100° C. lower than the magnetic annealing temperature, preferably from 100 to 250° C. lower, more preferably from 200 to 250° C. lower than the magnetic annealing temperature. When the glass frit is blended, not only the strength is made higher after the annealing but also the fluidity of the powder is improved.

The amount of the glass frit blended is preferably from 0.3 to 1.0% by mass to the whole amount of the soft magnetic powder. When the amount is adjusted to this range, both of the high magnetic permeability of more than 50 and the high radial crushing strength of more than 15 MPa can be obtained.

As the glass frit, it is possible to use TeO₂-based frit, V₂O₅-based frit, SnO-based frit, ZnO-based frit, P₂O₅-based frit, SiO₂-based frit, B₂O₃-based frit, Bi₂O₃-based frit, Al₂O₃-based frit, TiO₂-based frit, and the like. They may be used as a mixture of multiple kinds thereof. In particular, SnO-based, P₂O₅-based, TeO₂-based and V₂O₅-based frits and the mixtures thereof are characterized by the low softening point, and thus they are particularly effective when the strength is made higher in the low temperature burning. The PbO-based glass frit has a low softening point, but its environmental feasibility is problematically low, and thus it should not be used. The particle size of the glass frit can be selected from a range of 0.1 to 20 μm, and the finer the size, the higher the strength, because of the increased contact points with the soft magnetic metal powder.

The pressed powder magnetic core material of the present invention may be blended, if necessary, with a solid lubricant. The soft magnetic metal powder used in the present invention has a poor plastic deformation, and thus it is difficult to cause spring back upon mold-releasing, and the compression molding and the releasing can be easily performed even if the solid lubricant is not blended. It is desirable, however, to blend a small amount of the solid lubricant in terms of elongation of the life of the mold and acquisition of the fluidity of the soft magnetic powder. It is also possible to improve the bulk density and to increase the density of the pressed powder, for reducing the friction among the powder particles. The amount thereof blended is preferably about at most 1% by mass. When an excess amount is blended, the density of the pressed powder becomes low, thus resulting in the decreased magnetic properties and strength.

The solid lubricant may include zinc stearate, calcium stearate, magnesium stearate, barium stearate, lithium stearate, iron stearate, aluminum stearate, stearic amide, ethylene-bis-stearic amide, oleic amide, ethylene-bis-oleic amide, erucic amide, ethylene-bis-erucic amide, lauric amide, palmitic amide, behenic amide, ethylene-bis-capric amide, ethylene-bis-hydroxystearic amide, montanoic amide, polyethylene, oxidized polyethylene, starch, molybdenum disulfide, tungsten disulfide, graphite, boron nitride, polytetrafluoroethylene, lauroyl lysine, melamine cyanurate, and the like. They may be used alone or as a mixture of multiple kinds. The solid lubricant may be mixed by using a mixer such as a V-type mixer or a double cone-type mixer.

When the compression molding and the magnetic annealing are performed using the pressed powder magnetic core material described above, a pressed powder magnetic core excellent in mechanical strength, i.e., a radial crushing strength of 10 MPa or more, can be obtained.

The method for producing the pressed powder magnetic core using the Fe-based amorphous alloy powder is explained below as one example.

An insulation coated iron-based amorphous alloy powder having a particle size of 1 to 200 μm, and PVA having a degree of polymerization of 100 to 1000 and a degree of saponification of 50 to 100% by mole are prepared, and a 5 to 15% by mass aqueous solution containing the same is produced, which is used as the granulation binder liquid.

The Fe-based amorphous alloy powder and the glass frit are uniformly dispersed in the granulation binder liquid. It is possible to mix the glass frit with the powder after the granulation, but the case in which the alloy powder is dispersed in the granulation binder solution and then the glass frit is blend therewith upon the granulation can provide a more uniform dispersion.

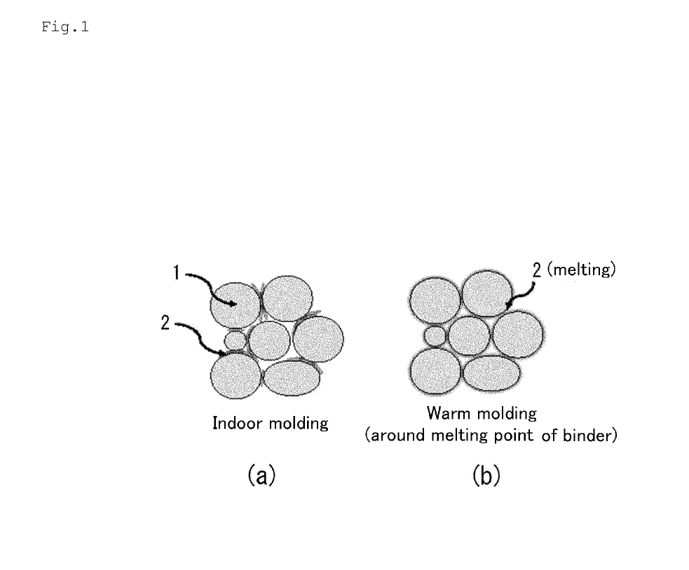

A mold is filled with the granulated iron-based amorphous alloy powder, and the compression molding is performed at a temperature approximately equal to or lower than the melting point of the granulation binder. FIGS. 1 (a) and 1 (b) show states during the compression molding. FIG. 1 (a) is a schematic view of a state after performing the compression molding at room temperature, and FIG. 1 (b) is a schematic view of a state after warm treatment. A granulation binder 2 is dispersed among particles of a soft magnetic powder 1 such as the iron-based amorphous alloy powder (FIG. 1 (a)). After the warm treatment, the particles of the soft magnetic powder 1 adheres to each other through the granulation binder 2 melted on the particle surface of the soft magnetic powder 1 (FIG. 1 (b)).

The compression molding pressure is from 1000 to 2000 MPa, more preferably from 1500 to 2000 MPa. The compression molding temperature is around the melting point of PVA or lower. Here, “temperature around a melting point or lower” refers to a melting point+less than 30° C. The warm treatment by heating is performed for flowing PVA in the molded product, whereby the shape-keeping property is increased.

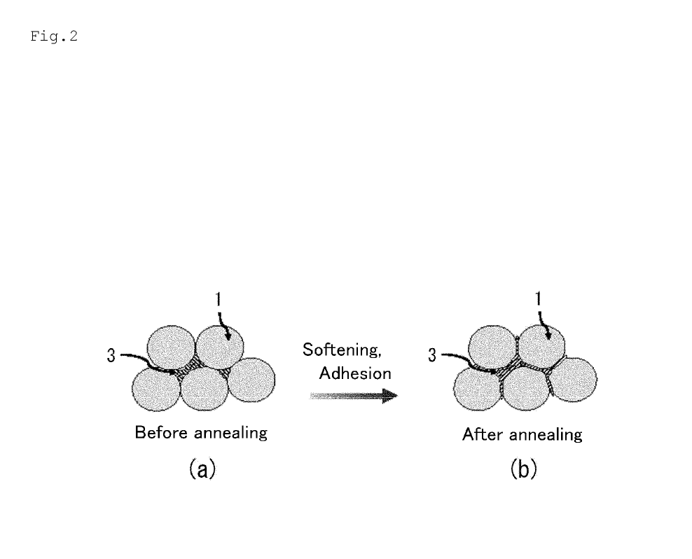

The compression-molded product, obtained by the compression molding, is subjected to the magnetic annealing. The annealing is performed in order to release the stress caused inside the iron-based amorphous alloy during the compression molding, and to melt the glass frit. FIGS. 2 (a) and 2 (b) show states during the magnetic annealing. FIG. 2 (a) is a schematic view of a state at the beginning of the magnetic annealing, and FIG. 2 (b) is a schematic view of a state after the magnetic annealing. A glass frit 3 is dispersed among the particles of the soft magnetic powder 1 such as the iron-based amorphous alloy powder (FIG. 2 (a)). After the magnetic annealing, the particles of the soft magnetic powder 1 adhere to each other through the glass frit 3 (FIG. 2 (b)). The granulation binder is thermally decomposed at a temperature of the magnetic annealing. When the magnetic annealing is performed, the magnetic properties are improved, and in addition the glass frit, which has been softened and melted, binds the iron-based amorphous alloy powder particles to each other, thus resulting in the highly strengthened molded product. When it is necessary to remove the lubricant or binder, a degreasing step is suitably provided after the magnetic annealing.

### EXAMPLES

### Examples 1 to 5 and Comparative Examples 1 and 2

As the iron-based amorphous alloy powder used in Examples 1 to 5 and Comparative Examples 1 and 2, a powder having a Fe—Cr—Si—B—C-based composition and a particle size distribution of 1 to 200 μm was prepared. The iron-based amorphous alloy powder has an insulating coating film formed of sodium silicate, and the insulating coating film was formed having a thickness of about 5 to 50 nm using a tumbling fluidized bed apparatus.

As the granulation binder, PVA manufactured by JAPAN VAM & POVAL Co., Ltd. (trademark: JMR-8M, degree of polymerization: 190, degree of saponification: 65.4% by mole, melting point: 145° C.) was prepared, and a 10% by mass aqueous PVA solution was produced. Blended with the aqueous PVA solution was a TeO₂—V₂O₅-based glass frit (particle size: 1 μm) in an amount of 0.5% by mass to the whole amount of the iron-based amorphous alloy powder, whereby the glass frit could be uniformly dispersed on the surface of the iron-based amorphous alloy powder. The amount of the PVA blended (as a solid content) was adjusted to 0.5% by mass to the whole amount of the iron-based amorphous alloy powder. As the lubricant, zinc stearate was blended in an amount of 0.5% by mass to the whole amount of the iron-based amorphous alloy powder, whereby a mixture was obtained.

Using the mixture described above, granulation was performed in MP-01 tumbling fluidized bed apparatus manufactured by Powrex Corporation. The granulated powder was subjected to compression molding at 1470 MPa using a mold capable of forming a ring specimen having an outer diameter of 20 mm×an inner diameter of 2 mm×a height of 6 mm. At that time, as shown in Table 1, heating was performed so that the mold temperature and the powder temperature were from room temperature to 200° C. during the compression molding.

After that, the compression-molded product was subjected to magnetic annealing at 480° C. for 15 minutes in the air atmosphere to obtain a pressed powder magnetic core.

A density, initial magnetic permeability, and iron loss of the obtained ring specimen were measured in the following methods. A radial crushing strength was measured before and after the magnetic annealing in the following method. The measurement results are shown in Table 1.

### [Density]

It was calculated from a size and a weight of the pressed powder magnetic core.

### [Initial Magnetic Permeability]

It was calculated from a series self-inductance in a condition of a frequency of 1 kHz, the number of windings, and a size, using Impedance Analyzer IM 3570, manufactured by Hioki EE. Corporation.

### [Iron Loss]

It was measured using B-H Analyzer SY-8219 manufactured by Iwatsu electric Co., Ltd.

### [Radial Crushing Strength]

It was measured using Autograph Precision Universal Tester AG-Xplus manufactured by Shimadzu Corporation.

TABLE 1

| | | | | | Radial crushing | |
|---|---|---|---|---|---|---|
| | Temperature | | Initial | Iron | strength, MPa | |
| | (° C.) of mold | Density | magnetic | loss, | Before | After |
| | and powder | g/cm³ | permeability | kW/m³ | annealing | annealing |
| Example 1 | 25 | 5.41 | 56 | 576 | 2 | 20.7 |
| Example 2 | 80 | 5.43 | 55 | 568 | 2.8 | 20.3 |
| Example 3 | 100 | 5.45 | 58 | 562 | 4.5 | 21.5 |
| Example 4 | 125 | 5.46 | 61 | 565 | 6.2 | 20.9 |
| Example 5 | 150 | 5.45 | 60 | 572 | 7.8 | 21.2 |
| Comparative | 175 | — | — | — | collapse | — |
| Example 1 | | | | | | |
| Comparative | 200 | — | — | — | collapse | — |
| Example 2 | | | | | | |

The density and the magnetic permeability increased as the mold temperature and the powder temperature were increased. This is because the plastic fluidity of the iron-based amorphous alloy powder was increased, and the iron-based amorphous alloy powder occupied the spaces between the particles.

The strength increased as the mold temperature and the powder temperature were increased. This is because the fluidity of the PVA was increased as the temperature upon the molding is increased, and the binding property among the iron-based amorphous alloy particles was improved.

When the mold temperature and the powder temperature were higher than 150° C., the molded product collapsed after being discharged. This is because PVA was melted outside the pressed powder. As a result, only little PVA, which bounds the iron-based amorphous alloy powder particles, remained, and thus the shape of the pressed powder magnetic core could not be retained.

### Examples 6 to 8 and Comparative Examples 3 to 7

A ring specimen being a pressed powder magnetic core was obtained in the same composition and conditions as in Example 5 except that a glass frit (particle size: 1 μm) shown in Table 2 was used. The density, initial magnetic permeability, and iron loss were measured in the same manner as in Example 5. The measurement results are shown in Table 2 together with the results in Example 5.

TABLE 2

| | | | | | | | Radial |
|---|---|---|---|---|---|---|---|
| | Glass frit | | | | Initial | Iron | crushing |
| | Main | Softening | Amount, | Density | magnetic | loss, | strength, |
| | component | point, ° C. | % by mass | g/cm³ | permeability | kW/m³ | MPa |
| Example 5 | TeO₂•V₂O₅ | 321 | 0.5 | 5.45 | 60 | 572 | 21.2 |
| Example 6 | SnO•P₂O₅ | 325 | ↑ | 5.44 | 59 | 569 | 20.7 |
| Example 7 | V₂O₅ | 362 | ↑ | 5.45 | 59 | 575 | 15.3 |
| Example 8 | Bi₂O₃•B₂O₃ | 389 | ↑ | 5.47 | 61 | 580 | 11.8 |
| Comparative | SiO₂•B₂O₃ | 431 | ↑ | 5.46 | 59 | 584 | 6.4 |
| Example 3 | | | | | | | |
| Comparative | Bi₂O₃•B₂O₃ | 440 | ↑ | 5.45 | 60 | 588 | 5.2 |
| Example 4 | | | | | | | |
| Comparative | Bi₂O₃•ZnO | 415 | ↑ | 5.47 | 61 | 612 | 8.5 |
| Example 5 | | | | | | | |
| Comparative | Bi₂O₃•B₂O₃ | 472 | ↑ | 5.44 | 57 | 606 | 3.2 |
| Example 6 | | | | | | | |
| Comparative | None | — | — | 5.46 | 63 | 581 | 2.2 |
| Example 7 | | | | | | | |

The density of the molded product was not greatly influenced by blending the glass frit. The magnetic permeability, which highly correlates with the density, was not also greatly changed.

The eddy current loss (iron loss) increased as the softening point of the glass frit was increased, on the basis of the results in Example 5. This is because the glass frit, which had been softened and flowed, increased the insulating property of the pressed powder.

When the glass frit having a comparatively high melting point was blended, as in Comparative Examples 3 to 6, the iron loss became higher than that in a case where no glass frit was blended (Comparative Example 7). This is because the volume of the iron-based amorphous alloy powder, which occupied the magnetic core, was decreased.

It was observed that when the glass frit is blended, the radial crushing strength was improved. In particular, when the glass frit whose softening point was at least 100° C. lower than the magnetic annealing temperature was blended, the high radial crushing strength of more than 10 MPa could be obtained. This is owing to the difference of the fluidity of the low-melting-point glass.

### Examples 9 to 11 and Comparative Examples 8 to 10

A ring specimen being a pressed powder magnetic core was obtained in the same composition and conditions as in Example 5 except that the amount of the glass frit blended was changed to an amount shown in Table 3. The density, initial magnetic permeability, and iron loss were measured in the same manner as in Example 5. The measurement results are shown in Table 3 together with the results in Example 5.

TABLE 3

| | | | | | Radial |
|---|---|---|---|---|---|
| | Glass frit | | Initial | Iron | crushing |
| | Amount, % | Density | magnetic | loss, | strength, |
| | by mass | g/cm³ | permeability | kW/m³ | MPa |
| Example 9 | 0.3 | 5.45 | 61 | 565 | 16.5 |
| Example 5 | 0.5 | 5.45 | 60 | 572 | 21.2 |
| Example 10 | 0.7 | 5.47 | 56 | 563 | 23.2 |
| Example 11 | 1 | 5.46 | 53 | 566 | 28.4 |
| Comparative | 1.3 | 5.44 | 47 | 570 | 29.7 |
| Example 8 | | | | | |
| Comparative | 1.5 | 5.43 | 42 | 560 | 30.2 |
| Example 9 | | | | | |
| Comparative | 0.1 | 5.45 | 62 | 592 | 8.5 |
| Example 10 | | | | | |

Even if the amount of the glass frit blended was changed, there was no big difference in the density.

When the glass frit was blended in an amount within a range of 0.3 to 1.0% by mass, both the high magnetic permeability of more than 50 and the high radial crushing strength of more than 15 MPa could be obtained.

When the amount of the glass frit blended was more than 1.0% by mass, the magnetic permeability became low, i.e., less than 50, whereas when the amount of the glass frit blended was less than 0.3% by mass, the low radial crushing strength, i.e., less than 10 MPa, was shown. This is because when the amount of the glass frit blended was too large, the volume of the iron-based amorphous alloy powder, which occupied the magnetic core, was decreased, and thus the magnetic permeability became low. When the amount of the glass frit blended was too small, effect of binding the powder by the glass frit was decreased.

The following effects can be obtained from Table 1 to Table 3.

(1) The pressed powder magnetic core having a high strength of more than 10 MPa can be obtained by blending the glass frit whose softening point is a temperature being at least 100° C. lower than the magnetic annealing temperature.
(2) When the amount of the glass frit blended is selected from a range of 0.3 to 1.0% by mass, the pressed powder magnetic core in which the binding of the iron-based amorphous alloy powder particles to each other and the magnetic permeability are well-balanced can be obtained.
(3) When the compression molding is performed at a temperature being 50° C. lower than the melting point of PVA, the fluidity of the binder is increased to increase the number of contact points between the iron-based amorphous alloy and the binder, thus resulting in the dramatically increased shape-keeping property of the molded product.
(4) The glass frit is blended with the aqueous binder solution, and thus the glass frit is uniformly dispersed in the iron-based amorphous alloy powder.
(5) The molded product obtained after the magnetic annealing has the high strength owing to the glass frit, which has been melted and solidified in the magnetic annealing step.
(6) According to the present invention, it is difficult to cause chips and cracks, and the pressed powder magnetic core having the good handling property can be obtained.
(7) As described above, the iron-based amorphous alloy pressed powder magnetic core having the high strength can be obtained even after the compression molding and the magnetic annealing.

### INDUSTRIAL APPLICABILITY

The pressed powder magnetic core material, the pressed powder magnetic core, and the production method thereof according to the present invention produce the magnetic core having the high magnetic flux density, the high magnetic permeability, the low iron loss, and the excellent mechanical strength, and thus they can be utilized as a pressed powder magnetic core used in a frequency range of several tens to several hundreds of kHz as in a reactor or choke coil.

### REFERENCE SIGNS LIST

1 Soft magnetic powder
2 Granulation binder
3 Glass frit

1. A pressed powder magnetic core material comprising:
a granulation binder;
a soft magnetic powder in which an insulating coating film is formed on a particle surface; and
a TeO₂—V₂O₅-based glass frit whose softening point is a temperature being at least 100° C. lower than a magnetic annealing temperature.

2. The pressed powder magnetic core material according to claim 1, wherein the soft magnetic powder is an iron-based amorphous alloy powder.

3. The pressed powder magnetic core material according to claim 1, wherein the glass frit is contained in an amount of 0.3 to 1.0% by mass based on the whole amount of the soft magnetic powder.

4. The pressed powder magnetic core material according to claim 1, wherein the granulation binder is a polyvinyl alcohol having a degree of polymerization 1000 or less and a degree of saponification of 50 to 100% by mole.

5. The pressed powder magnetic core material according to claim 1, wherein
the soft magnetic powder is an iron-based amorphous alloy powder,
the glass frit is contained in an amount of 0.3 to 1.0% by mass based on the whole amount of the soft magnetic powder, and
the granulation binder is a polyvinyl alcohol having a degree of polymerization 1000 or less and a degree of saponification of 50 to 100% by mole.

6. A pressed powder magnetic core comprising the pressed powder magnetic core material according to claim 1, and having a radial crushing strength of 10 MPa or more.

7. A pressed powder magnetic core comprising the pressed powder magnetic core material according to claim 5, and having a radial crushing strength of 10 MPa or more.

8. A method for producing a pressed powder magnetic core using the pressed powder magnetic core material according to claim 1, the method comprising:
a step in which the pressed powder magnetic core material is subjected to a compression molding at a temperature approximately equal to or lower than a melting point of the granulation binder; and
a step in which a compression-molded product obtained by the compression molding is subjected to a magnetic annealing.
